(19) United States
(12) Patent Application Publication
(10) Pub. No.: US 2013/0329700 A1
(43) Pub. Date: Dec. 12, 2013

(54) MOBILE TERMINAL WITH A REDUCED HANDOFF DELAY TIME AND A WIRELESS NETWORK SYSTEM COMPRISING SAME

(71) Applicants: Sang Yup Han, Daegu (KR); Myung Chul Kim, Daejeon (KR)

(72) Inventors: Sang Yup Han, Daegu (KR); Myung Chul Kim, Daejeon (KR)

(73) Assignee: KOREA ADVANCED INSTITUTE OF SCIENCE AND TECHNOLOGY, Daejeon (KR)

(21) Appl. No.: 13/981,756

(22) PCT Filed: Dec. 12, 2011
(86) PCT No.: PCT/KR2011/009539

§ 371 Date: Aug. 29, 2013

(30) Foreign Application Priority Data
Feb. 1, 2011 (KR) 10-2011-0010292

(51) Int. Cl. H04W 36/08

(52) U.S. Cl. CPC H04W 36/08
USPC 370/331

(57) ABSTRACT

Disclosed are a mobile terminal with a reduced handoff delay time and a wireless network system comprising same. A mobile terminal according to one embodiment of the present invention comprises: a sensor unit for generating azimuth angle data; a memory unit which stores a base station table containing data about a next base station corresponding to the orientation of the mobile terminal in the current base station; and a handoff management unit which searches for one or more next base station(s) by using the azimuth angle data from the sensor unit and the base station table, and performs a scanning action with respect to the found next base station(s) in accordance with the search results.

### TECHNICAL FIELD

Exemplary embodiments of the present invention relate to a mobile terminal and a wireless network system comprising the same, and more particularly, to a mobile terminal with a reduced handoff delay time and a wireless network system comprising the same.

### BACKGROUND ART

Recently, with a rapidly increasing spread of a mobile terminal, hereinafter referred to as a mobile node, for example, a smart phone, a tablet personal computer, a laptop computer, and the like, a number of users using a wireless network, for example, the Institute of Electrical and Electronics Engineers (IEEE) 802,11, is increasing sharply. Base stations such as access points (APs) are installed in many buildings including, for example, school campuses, government offices, railway stations, airports, coffee shops, department stores, and the like, and the installed base stations cover most arras inside the buildings. A number of users and base stations is increasing simply, however, a long handoff delay time limits mobility, resulting in great inconvenience for users.

FIG. 1 illustrates a handoff process in a wireless network system according to a related art. As shown in FIG. 1, the handoff process refers to transferring a connection of a mobile node from a base station 11 to another base station 12 beyond a wireless range of the base station 11 to which the mobile node is currently being connected, in a wireless network system 10. Typically, the handoff process starts when a received signal strength indication (RSSI) is reduced to be less than a handoff threshold value. The mobile node measures an RSSI at a regular time interval, and for example, an Android system as one of the mobile operating systems (OS) performs this operation every three seconds.

The handoff process consists largely of three phases, scanning, authentication, and re-association. A handoff delay time is calculated by calculating a sum of time taken in each phase. Generally, for real-time data transmission applications, for example, voice over Internet Protocol (VoIP), video transmission, videoconference, and the like, a handoff delay time should be less than 50 milliseconds (ms).

Scanning, a process that occupies 98% of a total handoff delay time, refers to finding a base station to which a next connection is to be made, and may take several seconds based on algorithms applied. When a mobile node selects a base station to which a next connection is to be made, the scanning is followed by authentication. Authentication refers to a process of obtaining an access authority by transmitting qualification information of a mobile node to a new base station. Re-association refers to a process of a base station allocating a resource and synchronizing with a mobile node. Also, re-association may involve transmission of state information of a previous to base station to a new base station. The authentication and re-association, processes take different amounts of time, based on respective implementations, and may be assumed to each be completed in about 5 ms.

According to wireless network standard IEEE 802.11, scanning is classified into passive scanning and active scanning. In the passive scanning, a mobile node is receives a beacon frame transmitted from a base station periodically, in general, every 100 ms. Accordingly, the mobile node should wait on one channel for a period of time sufficient for receiving the beacon frame. In contrast, in the active scanning, after a mobile node broadcasts a probe request frame directly, the mobile node receives a probe response frame from a base station. Accordingly, the mobile. node should wait on one channel for a period of time sufficient for receiving the probe response frame.

For faster handoff, active scanning is more advantageous than passive scanning which. requires a relatively longer period of time. However, the active scanning is lengthy and has a limitation in real-time data transmission applications because the active scanning is performed on all channels. Wireless network standard IEEE 802.11b, supports at least eleven channels, and allows for passive scanning taking one second or longer and active scanning requiring a minimum of 200 ms or longer. In a wireless network system, an increase in a handoff delay time causes a limitation on mobility of a mobile node, and makes transmitting data in real time impossible while a mobile node is in motion.

### DISCLOSURE OF THE INVENTION

### Technical Goals

An aspect of the present invention provides a mobile terminal that may overcome issues of limited mobility of a mobile node due to an increase in a handoff delay time in a wireless network system and of being unable to transmit data in real time while the mobile node is in motion, and a wireless network system comprising the same.

### Technical Solutions

According to an aspect of the present invention, there is provided a mobile terminal according to an exemplary embodiment including a sensor unit to generate azimuth angle information, a memory unit to store a base station table including information associated with a next base station corresponding to a direction of the mobile terminal in a current base station, and a handoff management unit to search for at least one next base station using the azimuth angle information from the sensor unit and the base station table, and perform a scanning operation for a found next base station based on a result of the search.

According to another aspect of the present invention, there is provided a method of operating a mobile terminal, the mobile terminal including a base station table including information associated with a next base station corresponding to a direction of the mobile terminal in a current base station, the method including detecting the direction of the mobile terminal, searching for information associated with at least one next base station by referring to a result of detecting the direction of the mobile terminal and the base station table, performing a scanning operation for the found next base station, and receiving a result of the scanning operation, and attempting a handoff using the result of the scanning operation.

According to still another aspect of the present invention, there is provided a network system including a mobile terminal comprising at least one sensor to sense a movement direction and a base station table to store information associated with at least one base station corresponding to the movement direction, and a plurality of base stations connectable to the mobile terminal, and the mobile terminal may determine a next handoff target using the movement direction and information of the base station table.

### Effects of Invention

According to the above mobile terminal and the wireless network system comprising the same, a handoff delay time may be reduced by limiting a number of channels to be scanned and an effect of real-time data transmission applications while the mobile node is in motion may be produced, because the movement direction of the mobile terminal may be detected using the sensor embedded in the mobile terminal and the channel to he scanned next may be selected using the base station table included in the mobile terminal.

Also, according to the above mobile terminal and the wireless network system comprising the same, only when mobility is necessary, active/selective scanning may be used and accordingly, power consumption may be reduced and a simple algorithm may facilitate application to a mobile terminal.

Also, compatibility with an existing wireless network may be maintained by omitting modifications to an existing base station. Also, the mobile terminal may provide mobility alone by determining a handoff, which may reduce complexity in network design and construction, and by supporting mobility in a network not supporting mobility, for example, the Institute of Electrical and Electronics Engineers (IEEE) 802.11 and the like, an effect of complementing or replacing an existing nebular network may be obtained.

### BRIEF DESCRIPTION OF THE DRAWINGS

FIG. 1 is a diagram illustrating a handoff process in a wireless network system according to a related art.

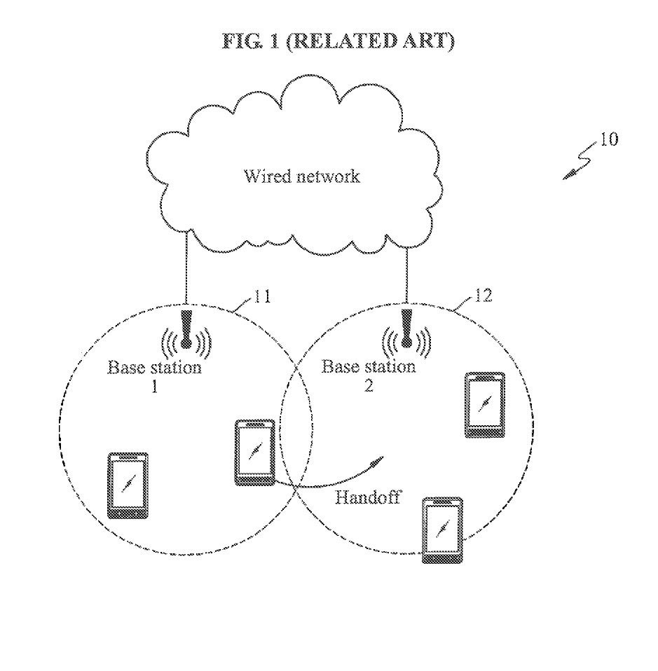

FIG. 2 is a block diagram illustrating a wireless network system according to an exemplary embodiment.

FIG. 3 is a block diagram illustrating an implementation example of a mobile terminal of a wireless network system according to an exemplary embodiment.

FIG. 4 is a block diagram illustrating a detailed implementation example of the mobile terminal of FIG 1.

FIG. 5A is a flowchart illustrating a process of calculating a movement direction of a mobile terminal according to an exemplary embodiment.

FIG. 5B is a diagram illustrating an example of an azimuth angle of the mobile terminal.

FIG. 6A is a diagram illustrating an example of base station table provision.

FIG. 6B is a diagram illustrating an example of a wireless network placement.

FIG. 6C is a diagram illustrating an example of a base station table.

FIG. 7A is a diagram illustrating an example of wireless network placement in a space in which an obstruction is present.

FIG. 7B is a diagram illustrating an example of a corresponding base station table.

FIG. 8 is a flowchart illustrating a handoff process performed between a mobile terminal and a system according to an exemplary embodiment.

### BEST MODE FOR CARRYING OUT THE INVENTION

These and other advantages and features of the present invention will become better understood upon consideration of the following detailed description of the invention when considered in connection with the accompanying drawings.

The embodiments are described below in order to explain the present invention by referring to the figures. Like reference numerals refer to the like elements throughout.

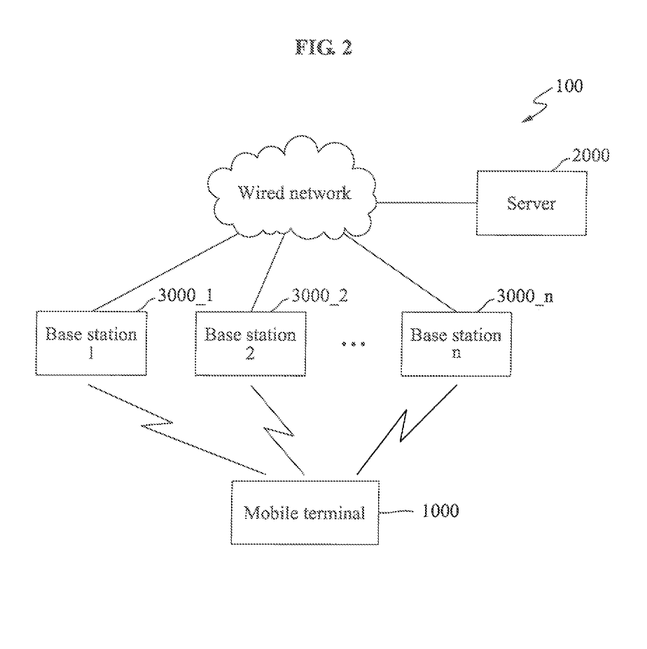

FIG. 2 is a block diagram illustrating a wireless network system 100 according to an exemplary embodiment. As shown in FIG. 2, the wireless network system 100 may include a mobile node or a mobile terminal 1000, at least one server 2000, and a plurality of base stations or access points (APs) 3000_1 to 3000_n. In the designation of the components or elements of the wireless network system 100, other terms may be used, and accordingly, the wireless network system 100 according to an exemplary embodiment may include devices identical or similar to the base station and the mobile terminal described in the foregoing.

Each of the plurality of base stations 3000_1 to 3000_n may be installed within a predetermined geographical region, and provide a network access service to the mobile node 1000, hereinafter referred to as a mobile terminal, located within the corresponding geographical region. Also, each of the base stations 3000_1 to 3000_n may access a wired network. The server 2000 may be present in a network identical to or different from the base stations 3000_1 to 3000_n, and receive identification information and various requests for information from the mobile terminal 1000 and provide various types of services based on information validation.

When the mobile terminal 1000 goes beyond a wireless range of a current base station in the wireless network system 100, the mobile terminal 1000 may be connected to another base station through a handoff process. For example, in FIG. 2, when the mobile terminal 1000 goes beyond a wireless range of a current base station 3000_1 and moves to a second base station 3000_2, the mobile terminal 1000 may be connected to the second base station 3000_2 through a handoff process. The mobile terminal 1000 may detect a received signal strength indication (RSSI) received through the first base to station 3000_1, periodically, and when the RSSI is less than a handoff threshold value, perform a handoff process.

According to an exemplary embodiment, a handoff delay time may be shortened by reducing a number of channels to be scanned. In particular, a direction in which a mobile terminal moves may be detected using various sensors, for example, a terrestrial magnetism sensor, a digital compass, and the like, provided in the mobile terminal 1000, and a channel to be scanned may be searched for using a result of the detection. Also, a handoff delay time may be reduced by performing scanning selectively on only a selected channel by referring to the result of the detection.

According to well-known proposals for reducing a handoff delay time by a selective scanning operation, issues may be raised, for example, a great amount of time and labor may he required to construct a system including software modification of an existing base station, or applications may be limited to only a portion of a system using a mobile assisted handoff (MAHO) technique, for example, a global system for mobile communications (GSM), code division multiple access (CDMA), wideband CDMA (WCDMA), and the like. According to an exemplary embodiment to be described below, a handoff technique that may be applied easily to a current system environment by enhancing a configuration of the mobile terminal 100 without any modification to an existing base station is proposed, and be applicable to a wireless network system such as IEEE 802.11 and the like.

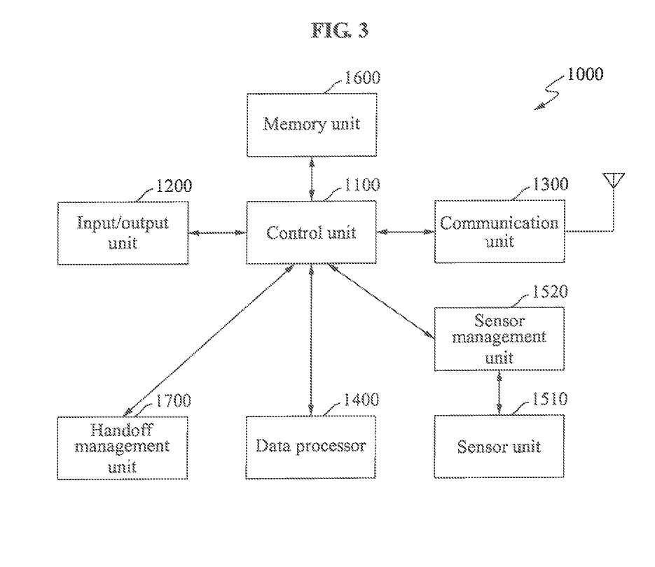

FIG. 3 is a block diagram illustrating an implementation example of a mobile terminal 1000 of a wireless network system according to an exemplary embodiment. As shown in FIG. 3, the mobile terminal 1000 may include a control unit 1100, an input/output unit 1200, a communication unit 1300, a data processor 1400, a sensor unit 1510, a sensor management unit 1520, a memory unit 1600, and a handoff management unit 1700. Although the sensor unit 1510 and the sensor management unit 1520 an illustrated as separate configurations in FIG. 3 for a concise description, the sensor management unit 1520 may be included in the sensor unit 1510.

The control unit 1100 may control an overall operation of the mobile terminal 1000. For example, the other function blocks of FIG. 3, in particular, the input/output unit 1200, the communication unit 1300, the data processor 1400, the sensor unit 1510, the sensor management unit 1520, the memory unit 1600, and the handoff management unit 1700 may operate under the control of the control unit 1100.

The input/output unit 1200 may correspond to a device that may receive an input from a user through a keypad or a touch screen and display a motion state of the mobile terminal 1000. Also, the communication unit 1300 may include a transmitting/receiving unit, and perform operations of frequency-upconverting an audio/data signal that may be transmitted through an antenna or frequency-downconverting a signal received through an antenna. Also, the data processor 1400 may extract an audio/data signal from received symbol streams by demodulating, deinterleaving, and decoding a received signal based on a particular receiver processing technology, or generate symbol streams to be transmitted by processing the audio/data signal through a complementary operation with the reception processing.

To perform a handoff process according an exemplary embodiment, the sensor unit 1510 may include at least one sensor. The sensor unit 1510 may include at least one sensor including a terrestrial magnetism sensor or a digital compass. The sensor unit 1510 may further include various sensors, for example, an acceleration sensor, a global positioning system (UPS), and the like, and in addition to the various sensors, include other sensor for generating azimuth angle information.

The sensor management unit 1520 may process various sensing signals from the sensor 1510 to generate a result of the sensing. Also, the memory unit 1600 may store a general program, an application program, and various data for storage, and further store a base station table for searching for a base station and a channel to be scanned by referring to the sensing result of the sensor management unit 1520. The handoff management unit 1700 may search for a base station and a channel to be scanned by referring to the base station table stored in the memory unit 1600 and the various sensing results obtained through the sensor unit 1510 and the sensor management unit 1520.

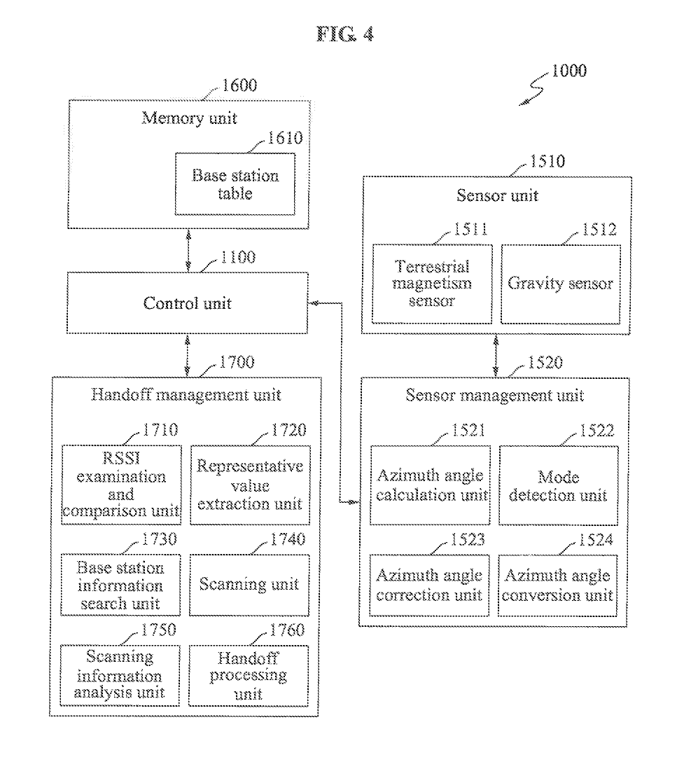

An operation of seas for a base station and a channel to be scanned according to an exemplary embodiment and a handoff process using the same as described with reference to FIG. 4 below.

FIG. 4 is a block diagram illustrating a detailed implementation example of the mobile terminal 1000 of FIG. 3. Illustration of some components or elements of FIG. 3, for example, the input/output unit 1200, the communication unit 1300, and the data processor 1400 is omitted in FIG. 4 for conciseness.

As shown in FIG. 4, the memory unit 1600 may store a base station table 1610, and the sensor unit 1510 may include at least a terrestrial magnetism sensor 1511 and a gravity sensor 1512. Also, the sensor management unit 1520 may include an azimuth angle calculation unit 1521, a mode detection, unit 1522, an azimuth angle correction is unit 1523, and an azimuth angle conversion unit 1524. Also, the handoff management unit 1700 may include an RSSI examination and comparison unit 1710, a representative value extraction unit 1720, a base station information search unit 1730, a scanning unit 1740, a scanning information analysis unit 1750, and a handoff processing unit 1760.

The sensor unit 1510 may generate and provide various sensing signals to the sensor management unit 1520. For example, the terrestrial magnetism sensor 1511 may generate a sensing signal associated with detection of a movement direction of the mobile terminal 1000 and provide the sensing signal to the sensor management unit 1520, and the gravity sensor 1512 may generate a sensing signal associated with detection of a landscape or portrait mode of the mobile terminal 1000 and provide the sensing signal to the sensor management unit 1520. The sensor management unit 1520 may process the various sensing signals to generate various pieces of information.

The azimuth angle calculation unit 1521 may calculate a current azimuth angle of the mobile terminal 1800 using the sensing signal. The azimuth angle may he defined to be an angle measured from a magnetic north of the earth to a y axis of the mobile terminal 1000 in a clockwise direction. The mode detection unit 1522 may detect a current display direction, for example, a landscape mode or a portrait mode, of the mobile terminal 1000 using the sensing signal. The display direction of the mobile terminal 1000 may he detected to determine the azimuth angle of the mobile terminal 1000 because an azimuth angle is changed based on whether the mobile terminal 1000 is in a landscape mode or a portrait mode.

The azimuth angle collection unit 1523 may correct the azimuth angle calculated by the azimuth angle calculation unit 1521 using a result of calculating the azimuth angle and a result of detecting the display direction. For example, a correction may be executed to obtain a new azimuth angle by applying the calculation result of the azimuth angle to an equation based on the detection result of the display direction. The azimuth angle conversion unit 1524 may convert the corrected azimuth angle to one of the plurality of representative direction indications. For example, a numerically calculated azimuth angle may be indicated as one of the representative directions, the representative directions may include north (N), northeast (NE), east (E), southeast (SE), southwest (SW), west (W), northwest (NW), north-northeast (NNE), east-northeast (ENE), and east-southeast (ESE), and the corrected azimuth angle may be converted to a representative direction corresponding to the value.

The handoff management milt 1700 may retrieve the converted value of the azimuth angle from the sensor management unit 1520 and the base station table 1610 information stored in the memory unit 1600, and perform a handoff process by referring to the converted value of the azimuth angle and the base station table 1610 information. The RSSI examination and comparison unit 1710 may examine an RSSI of a base station currently connected to the mobile terminal 1000 at a predetermined cycle. Also, when the RSSI of the base station currently connected is less than a handoff threshold value, a result of the comparison may be generated to enable a handoff process to he initiated.

The representative value extraction unit 1720 may extract a representative value using a value converted to a representative direction. For example, a representative direction value obtained by converting an azimuth angle may be accumulated for a predetermined period of time, and a representative value may be extracted from a result of the accumulation. For example, an accumulation operation may be performed on a value converted to a representative direction for five seconds, and a most frequent direction in the accumulated values may be extracted as a representative value, or calculate an average value or a median value of the accumulated values, and extract the average or median value as a representative value.

The base station information search unit 1730 may search for a channel and a base station to be scanned next in the base station table based on the current base station and the extracted representative value. Based on a result of the search, a subsequent search may be conducted for at least one base station and channel to be connected next to the mobile terminal 1000. A detailed description of an operation of searching for a base station and a channel is provided below.

The scanning unit 1740 may perform a selective scanning operation on the found channel. A result of the scanning operation may he provided to the scanning information analysis with 1750. The scanning information analysis unit 1750 may select a base station to attempt a handoff by referring to the result of the scanning. For example, in a case in which information associated with a base station is received through a certain channel, information associated with another unexpected base station may be included. Accordingly, the scanning information analysis unit 1750 may exclude information associated with another unexpected base station, calculate an RSSI value for each of expected base stations, and select a base station having a highest RSSI value among results of the calculation.

The handoff processing unit 1760 may perform an actual handoff processing operation with respect to the selected base station. The handoff processing operation may include authentication and re-association processes.

As a result of measuring a handoff delay time and a packet loss ratio by applying an exemplary embodiment to a mobile terminal actually, the handoff delay time may be reduced to a minimum of 21 ms so that real-time data transmission applications, for example, VoIP, video transmission, videoconference, and the like, may be applied effectively while the mobile terminal is in motion. Also, according to an exemplary embodiment, an advantage may he provided of being readily applicable to an actual system by simply modifying software embedded in a mobile terminal absent modifications to an existing base station.

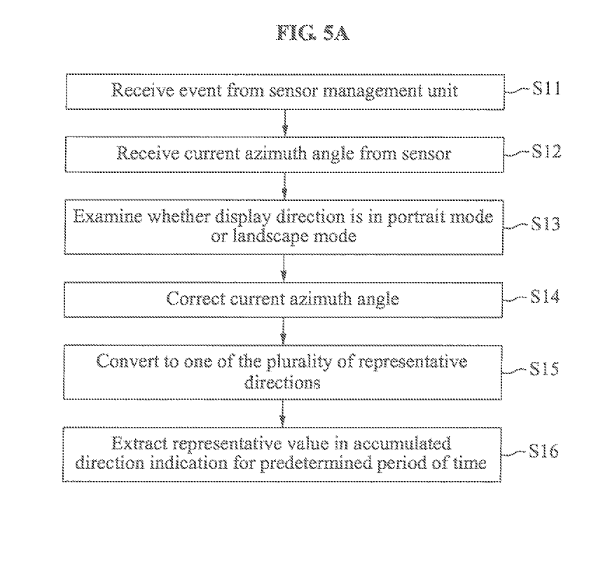

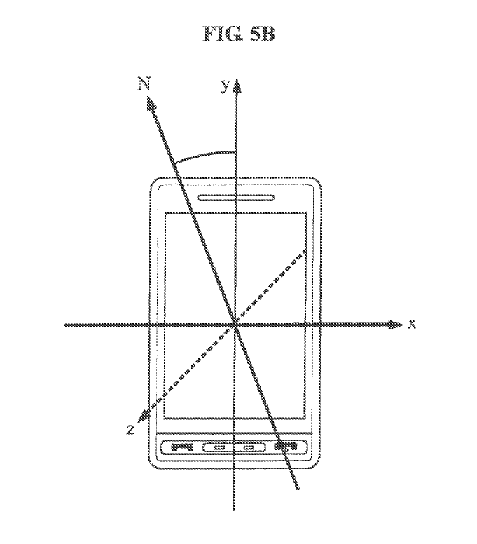

FIG. 5A is a flowchart illustrating a process of calculating a movement direction of a mobile terminal according to an exemplary embodiment, and FIG. 5B is a diagram illustrating an example of an azimuth angle of the mobile terminal. As shown in FIG. 5A, in operation S11, an event may be received from a sensor management unit, also known as a sensor manager, and whether a sensor value is changed may be determined by analyzing the received event. The sensor management unit may correspond to one of the components of a mobile OS employed in the mobile terminal, and track a change in a sensor value and may provide an event. A type of a sensor and time interval to be used to track the change may be set by the sensor management unit.

Also, in operation S12, a current azimuth angle may be received from a sensor of the mobile terminal. The azimuth angle may be defined to be an tingle measured from a magnetic north of the earth to a y axis of the mobile terminal in a clockwise direction. As shown in FIG. 5B, when an angle measured from a magnetic north of the earth to a y axis of the mobile terminal in a clockwise direction is α, α may correspond to an azimuth angle of the mobile terminal. A value of α may have a value in a range from 0 to 360, in which 90 represents east, 0 and 360 represent north.

Also, in operation S13, a current display direction of the mobile terminal may be examined. The mobile terminal may have a portrait mode and a landscape mode based on a display direction. In FIG. 5B, the mobile terminal in a portrait mode is illustrated, and when the mobile terminal is laid on a left or right side in the drawing, the mobile terminal may be in a landscape mode. When the mobile terminal is switched from a portrait mode to a landscape mode, an azimuth angle may be changed, and accordingly when the mobile terminal goes into a landscape mode, the azimuth angle may be corrected as follows.

$$In a case in which the mobile terminal is laid on a left side , a \{ \begin{matrix}{a}_{L} - 90 , & if {a}_{L} \geq 90 \\ {a}_{L} - 90 + 360 , & if {a}_{L} < 90\end{matrix} \qquad 〈 Equation 1 〉$$

Here, α denotes a value after correction, and α_{L} denotes a value before correction.

$$In a case in which the mobile terminal is laid on a right side , \\ \begin{matrix} a \{ \begin{matrix}{a}_{R} + 90 , & if {a}_{R} \leq 270 \\ {a}_{R} + 90 - 360 , & if 270 < {a}_{R} \leq 360\end{matrix} & \end{matrix} \qquad 〈 Equation 2 〉$$

Here, α denotes a value after correction, and α_{R} denotes a value before correction.

A display of the mobile terminal may differ based on whether the mobile terminal is in a portrait mode or a landscape mode, and accordingly, the mobile terminal may be monitored for a mode continuously at a level of the mobile OS. Whether the mobile terminal is in a portrait mode or a landscape mode may be determined by receiving an event provided by the mobile OS or by calling a command.

Subsequently in operation S15, the corrected azimuth angle may be converted to one of the plurality of representative direction indications. For example, the plurality of representative directions may include N, NE, B, SE, SW, W, NW, NNE, ENE, and ESE, and the corrected azimuth angle may be converted to one representative direction among the representative directions. In operation S16, a representative value may be extracted from a direction indication accumulated for a predetermined period of time. A great value change may be made by even a small motion, because the sensor embedded in the mobile terminal is very sensitive. Accordingly, a representative value in a direction indication accumulated for a predetermined period of time may be used. For example, a most frequent direction in a direction indication accumulated for five seconds may be used, or an average value or a median value of the accumulated direction indication may be used. A time interval to be used to extract may be set to reflect a direction change of the mobile terminal sufficiently but not excessively sensitively. By extracting the representative value, the current movement direction of the mobile terminal may be calculated.

According to an exemplary embodiment, a channel to be scanned next may be searched for by combining the obtained movement direction information of the mobile terminal with a base station table. The base station table may store a physical address of a base station, for example, a media access control (MAC) address, a basic service set identifier (BSSID), and the like, and information associated with at least one optimal base station for each direction. An operation of searching for a channel to be scanned is described in detail below.

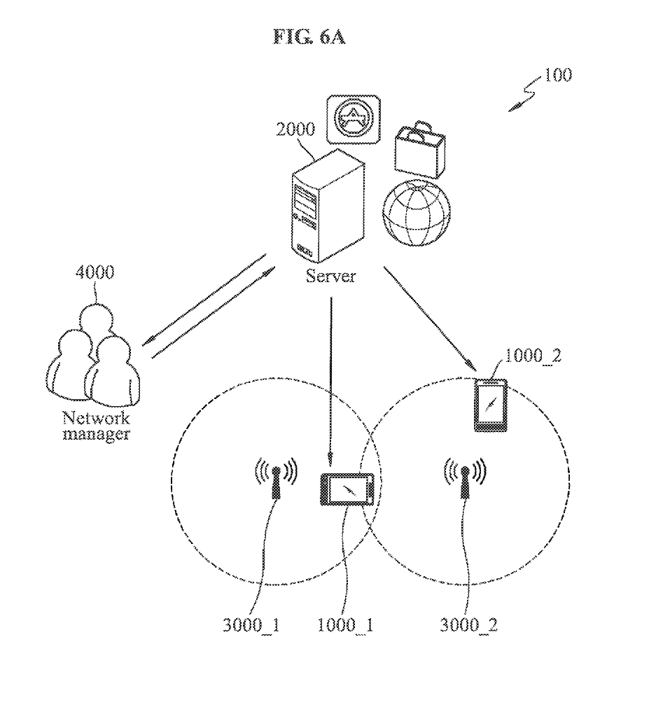

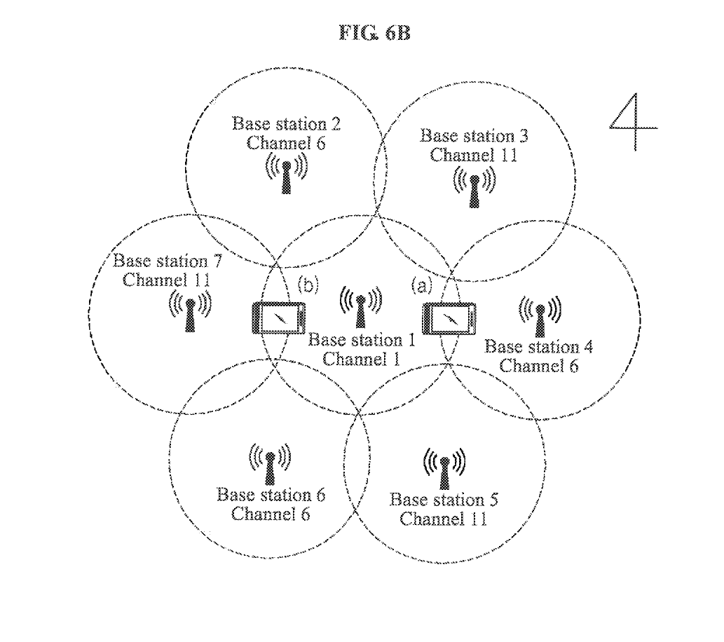

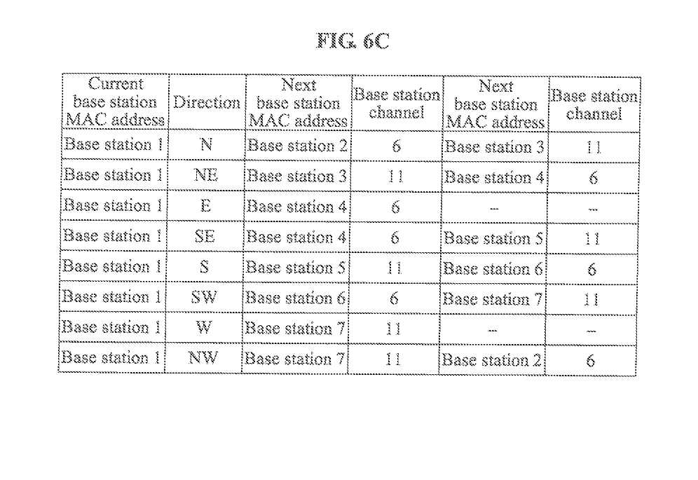

FIG. 6A is a diagram illustrating an example of base station table provision, FIG. 6B is a diagram illustrating an example of a wireless network placement, and FIG. 6C is a diagram illustrating an example of a base station table. As shown in FIG. 6A, each of the mobile terminals 1000_1 and 1000_2 may access the server 2000 using a network access service provided by each of the base stations 3000_1 and 3000_2 in the wireless network system 100. According to an exemplary embodiment, the base station table may be distributed from the server 2000 to the mobile terminals 1000_1 and 1000_2. The server 2000 may include mobile terminal manufacturer server, a mobile communication service provider server, an application server, for example, AppStore of Apple, Android Market of Google, a public server, and the like. The server 2000 may provide the base station table using various methods. For example, the base station table may be provided through a dedicated or common protocol. A network manager 4000 may register a network environment in the server 2000 to enable the server 2000 to provide the base station table.

The mobile terminals 1000_1 and 1000_2 be also provided with the base station table using various methods. When the mobile terminals 1000_1 and 1000_2 access a wireless network, the mobile terminals 1000_1 and 1000_2 may be connected to the server 2000 automatically at a level of the mobile OS and may obtain a corresponding base station table. Alternatively, the base station table may be obtained is by a user downloading an application created by the network manager 4000 directly from an application server, for example. AppStore of Apple, Android Market of Google, and the like.

Also, when the mobile terminals 1000_1 and 1000_2 operate according to exemplary embodiments, the mobile OS using an algorithm of the present invention may be also distributed to the mobile terminals 1000_1 and 1000_2 easily through the various exemplary servers 2000 so that upgrade may be performed. This may facilitate modification to a conventional mobile terminal or well-known terminal and may provide a user with convenience in upgrade.

FIG. 6B is a diagram illustrating an example of a wireless network placement in an open space, and FIG. 6C is a diagram illustrating a base station table corresponding to the environment of FIG. 6B. Although the base station table of FIG. 6C shows information associated with a next base station and a next channel of a base station, here, Base station 1, it may be the same with other base station.

According to an exemplary embodiment, a channel to he scanned next may be searched for without performing an operation of measuring a current location of a mobile terminal. For example, en exemplary embodiment may eliminate the need for a location measuring system, such as, a wireless fidelity (Wi-Fi) location measuring system, and search for a channel to be scanned next even though a current location of a mobile terminal is unknown.

As shown in FIGS. 6B and 6C, assume that a first mobile terminal (a) and a second mobile terminal (b) are connected to a first base station, Base station 1. The situation is that the first mobile terminal (a) is moving to east (E), and the second mobile terminal (b) moves to west (W), stops, and turns in the opposite direction.

For the first mobile terminal (a), a channel to be scanned next may be searched for using a base station table. For example, it may be found that a channel to be scanned next is 6 and a base station to be connected is a fourth base station Base station to 4 because a movement direction of the first mobile terminal (a) is east (E). Also, according to the base station table, in a case of the second mobile terminal (b), a fourth base station Base station 4, and Channel 6 may be found, and at a glance, it seems to be a mechanism failure. However, when the second mobile terminal (b) stays at a current location or moves to east (E), the second mobile terminal (b) may be still in a coverage area of the first base station Base station 1, and accordingly, erroneous performance eta handoff operation may be prevented. When the second mobile terminal (b) returns in the opposite direction again and moves to west (W), it may be easily found by the base station table that a channel to be scanned next is 11 and a base station to be connected is a seventh base station Base station 7.

The wireless network placement illustrated in FIG. 6B corresponds to a network in an open space. However, most wireless networks are present in a space including an indoor area, which in turn, may imply the presence of an obstruction such as, for example, a wall or a corridor. A motion of the mobile terminal may be limited because this obstruction causes many limitations on mobility of a mobile terminal, which makes estimating a movement direction of a mobile terminal easy in a space in which an obstuction is present. That is, a channel to be scanned next may be determined more easily in a space in which an obstruction is present.

According to FIG. 6C, a base station table applied to a mobile terminal according to an exemplary embodiment may have mapping information of a current base station or current base station information to at least one next base station or next base station information. For example, a plurality of base stations corresponding respectively to a plurality of directions with respect to a current base station Base station 1 may be mapped to the current base station Base station 1, and corresponding mapping information may be stored in the base station table. In this example, the base station table may store only information associated with a relative location between at least two base stations rather than precise absolute location information of each base station such as, for example, latitude and longitude. Accordingly, even though absolute location information of a mobile terminal or a base station is unknown, a correct handoff operation may he implemented by estimating a rough and relative location between the mobile terminal and the base station.

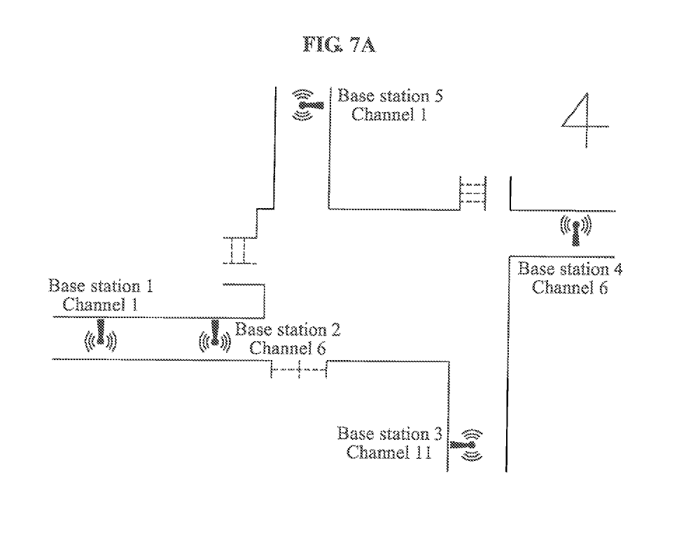

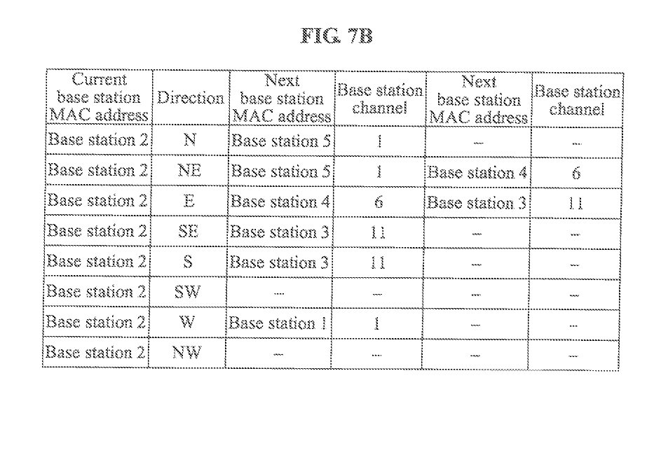

FIG. 7A is a diagram illustrating an example of wireless network placement in a space in which an obstruction is present, and FIG. 78 is a diagram illustrating an example of a corresponding base station table. For example, as shown in FIG. 7A, a number of probabilities that a user may move in a corridor is finite, and the user may only move from east to west or vice versa, or from south to north vice versa. A lobby is in the center, but installing a base station in the middle of the lobby is unusual. Accordingly, a base station table may be configured more simply in a space in which an obstruction is present. Although FIG. 7B exhibits a base station table corresponding to a space of FIG. 7A in which only one base station, for example, a second base station Base station 2, is shown, it may be the same with other base station.

As shown in FIGS. 7A and 7B, assume that a mobile terminal (not shown) is located in a second base station Base station 2 and is moving to west (W). When the mobile terminal is detected to be moving to west (W), reference may be made to a base station table corresponding to the second base station Base station 2. As shown in FIG. 7B, it may be easily found that a channel to be scanned next is 1 and a base station to be connected is a first base station Base station 1. Also, assume that at mobile terminal is located in a second base station Base station 2 and is moving to east (E). By referring to the base station table, a case in which a channel to be scanned next is 6 and a base station to be connected is a fourth base station Base station 4, and a case in which a channel to be scanned is 11 and a base station to be connected is a third base station Base station 3 may be found.

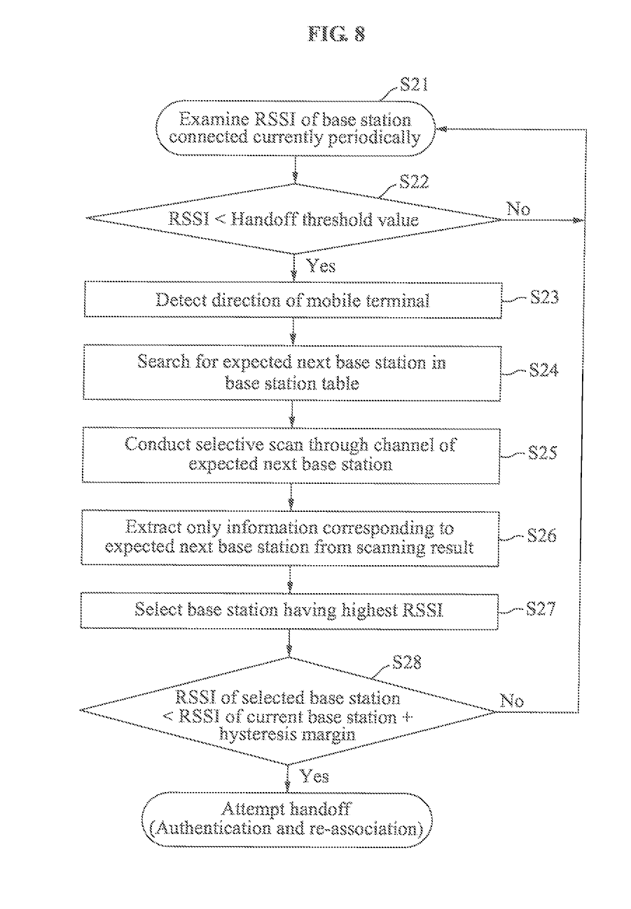

FIG. 8 is a flowchart illustrating a handoff process performed between a mobile terminal and a system according to an exemplary embodiment. As shown in FIG. 8, in operation S21, a mobile terminal may examine an RSSI of a base station or AP connected currently, periodically. Also, in operation S22, whether the examined RSSI is less than a handoff threshold value may be determined. When the examined RSSI is equal to greater than the handoff threshold value, handoff may not be performed and a process of examining an RSSI of a base station may be performed iteratively.

When the examined RSSI is less than the handoff threshold value, a channel to be scanned may be searched for, and a handoff operation may be performed by a selective scanning operation based on a result of the search. For this, first, a movement direction of the mobile terminal may be detected in operation S23. The movement direction of the mobile terminal may be made equally or similarly to the disclosure provided in the foregoing exemplary embodiment.

When the movement direction of the mobile terminal is detected, information of an expected next base station of the mobile terminal may be searched for by referring to the movement direction information and the base station table in operation S24. As seen in FIGS. 6C and 7B in the foregoing, a number of expected base stations may be plural, and may be none. In a case of no expected base station, all channels may become a target channel. After a channel to be scanned is determined, selective scanning may be performed toward a target channel of an expected base station in operation S25.

A result obtained by performing the scanning may include information associated with another unexpected base station because one channel is not exclusively possessed by one base station. Accordingly, only information associated with an expected base station may be extracted from the result of the scanning in operation S26, and an RSSI value for each base station may be calculated and a base station having a highest RSSI value among results of the calculation may be selected in operation S27.

Subsequently, an RSSI value of the selected base station may be compared to an RSSI value of the current base station in operation S28. When comparing the RSSI values, a comparison operation may be performed based on Equation 3. RSSI_current denotes an RSSI value of a current base station, and RSSI selected denotes an MR value of a selected base station. Also, H denotes a hysteresis margin.

Equation 3

RSSI_selected>RSSI_current+H

The reason for applying the hysteresis margin value is to prevent an excessive handoff attempt that may occur when a mobile terminal is within a handoff region. Also, a ping-pong effect may be prevented that a mobile terminal accesses different base stations frequently. In actual implementations, a handoff threshold value and a hysteresis margin H may be defined by Equation 4. However, this numerical value may be defined differently based on a type of a wireless network

Equation 4

Handoff Threshold=−70 dBm

H=+10 dBm

In the foregoing exemplary embodiment, an expected handoff delay time may be calculated through Equation 5 below.

Equation 5

T_{—scanning=}N*ChannelDwellTime

Handoff Delay=T_scanning+T_{—authentication+}T_reassociation

In Equation 5, N denotes a number of expected next base stations. Also, ChannelDwellTime denotes a time required to wait on one channel, specifically, a time taken to receive a probe response frame from a base station after transmitting a probe request frame. The ChannelDwellTime may be approximately 11 ms. Also, each of an authentication time T_authentication and a re-association time T_reassociation may be 5 ms. Accordingly, in a case in which a number of expected base stations is one, a handoff delay time may be 21 ms, and in a case in which a number of expected base stations is two, a handoff delay time may be 32 ms. This numerical value may be less than a maximum handoff delay time for real-time data transmission applications, that is, 50 ms.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A mobile terminal comprising:
a sensor unit to generate azimuth angle information;
a memory unit to store a base station table including information associated with a next base station corresponding to a direction of the mobile terminal in a current base station; and
a handoff management unit to search for at least one next base station using the azimuth angle information from the sensor unit and the base station table, and perform a scanning operation for a found next base station based on a result of the search.

2. The mobile terminal of claim 1, wherein the base station table further includes information associated with a physical address and a channel corresponding to the next base station, and
the handoff management unit conducts a scan through a channel corresponding respectively to the found next base station.

3. The mobile terminal of claim 1, wherein the sensor unit comprises;
an azimuth angle calculation unit to calculate an azimuth angle of the mobile terminal using a sensing signal of a first sensor;
a mode detection unit to detect a landscape mode or a portrait mode of the mobile terminal using a sensing signal of a second sensor;
an azimuth angle correction unit to correct the calculated azimuth angle using the calculated azimuth angle and the detected mode; and
an azimuth angle conversion unit to convert the corrected azimuth angle to a one direction value.

4. The mobile terminal of claim 1, wherein the handoff management unit comprises:
a base station information search unit to search for information associated with the next base station by referring to a first value representing a direction of the mobile terminal generated by processing the azimuth angle information and the base station table;
a scanning unit to perform a scanning operation for the found next base station; and
a handoff processing unit to perform a handoff process based on a result of the scanning operation.

5. The mobile terminal of claim 4, wherein the handoff management unit further comprises:
a received signal strength indication (RSSI) examination and comparison unit to detect an RSSI of a current base station of the mobile terminal and compare the detected RSSI to a threshold value;
a representative value extraction unit to accumulate the received azimuth angle information, periodically, and extract the first value from a result of the accumulation; and
a scanning information analysis unit to receive the result of the scanning operation and to select one base station among the at least one found next base station by analyzing the result of the scanning operation.

6. The mobile terminal of claim 1, wherein the mobile terminal performs a handoff process by determining a next handoff target directly based on the scanning operation for the next base station.

7. A wireless network system comprising the mobile terminal of claim 1.

8. A method of operating a mobile terminal, the mobile terminal comprising a base station table including information associated with a next base station corresponding to a direction of the mobile terminal in a current base station, the method comprising:
detecting the direction of the mobile terminal;
searching for information. associated with at least one next base station by referring to a result of detecting the direction of the mobile terminal and the base station table;
performing a scanning operation for the found next base station; and
receiving a result of the scanning operation, and attempting a handoff using the result of the scanning operation.

9. The method of claim 8, wherein the base station table further includes information associated with a physical address and a channel corresponding to the next base station as well as the information associated with the next base station, and the scanning operation is performed through a channel corresponding to the found next base station.

10. The method of claim 8, wherein the detecting of the direction of the mobile terminal comprises:
calculating an azimuth angle periodically using a sensing signal;
correcting the azimuth angle based on a display direction of the mobile terminal;
converting the corrected azimuth angle to one representative direction among a plurality of representative directions; and
detecting the direction of the mobile terminal by accumulating the converted representative direction and by calculating a frequency and/or an average value of the accumulated representative direction.

11. The method of claim 8, further comprising:
detecting a signal intensity of at least one next base station in the result of the scanning;
selecting a next base station having a highest signal intensity; and
comparing the signal intensity of the next base station to a sum of a signal intensity of the current base station and a hysteresis margin,
wherein the handoff attempt is made when the signal intensity of the next base station is greater than the sum of the signal intensity of the current base station and the hysteresis margin.

12. A non-transitory computer-readable storage medium storing a program comprising instructions to cause a computer to perform the method of operating the mobile terminal of claim 8.

13. A network system comprising:
a mobile terminal comprising at least one sensor to sense a movement direction and a base station table to store information associated with at least one base station corresponding to the movement direction; and
a plurality of base stations connectable to the mobile terminal,
wherein the mobile terminal determines a next handoff target using the movement direction and information of the base station table,

14. The network system of claim 13, wherein the base station table stores information associated with the at least one second base station and channel information corresponding to the movement direction of the mobile terminal in a first base station.

15. The network system of claim 13, wherein the network system further comprises a server, and
the base station table is distributed to the mobile terminal by the server.

16. The network system of claim 13, wherein the network system further comprises a server, and
software including the base station table to be distributed to the mobile terminal through the server.
